(19) United States
(12) Patent Application Publication
(10) Pub. No.: US 2007/0190841 A1
(43) Pub. Date: Aug. 16, 2007

(54) Optical connector system

(76) Inventor: Hendrikus Petrus Gijsbertus Van Der Steen, Den Dungen (NL)

Correspondence Address: HARRINGTON & SMITH, PC, 4 RESEARCH DRIVE, SHELTON, CT, 06484-6212, US

(21) Appl. No.: 10/587,527

(22) PCT Filed: Jan. 25, 2005
(86) PCT No.: PCT/EP05/00789

§ 371 Date: Jul. 26, 2006

(30) Foreign Application Priority Data
Feb. 2, 2004 (NL) 1025379

(51) Int. Cl. H01R 13/64

(52) U.S. Cl. 439/247

(57) ABSTRACT

The invention relates to an optical connector system including a backpanel and at least one substrate having at least one substrate housing assembly and a first interface part for establishing an optical interface. The backpanel an integrated second interface part adapted to complete said optical interface and said substrate housing assembly is adapted to provide relative movement of said substrate with respect to said optical interface.

The invention relates to an optical connector system comprising a backpanel and at least one substrate having at least one substrate housing assembly and a first interface part for establishing an optical interface.

Optical connector systems typically comprise a backpanel with a plurality of system cards or substrates. These substrates usually comprise both optical and electrical connections to establish optical and electrical interfaces with corresponding elements on the backpanel. Alignment typically is of crucial importance to provide a low loss optical interface. Therefore it is often required for such optical connector systems that the optical interfaces are completed before the electrical connections are established, as the latter may otherwise disturb the alignment for the optical interface.

U.S. Pat. No. 5,921,796 discloses a backpanel connector system comprising a backpanel connector, a board connector and a plurality of connector plugs for optical fibres. The backpanel connector comprises a first and a second housing. The second housing is slidably mounted in said first housing in a z-direction extending perpendicular to the bottom of the first housing. The backpanel connector system is designed to use both electrical and optical connectors. If the board connector and the backpanel connector are connected first the optical connection is established. The electrical connection requires a further approaching movement of the board connector and the backpanel connector, which movement is facilitated by the slidably mounted second housing of the board connector.

A drawback of such a backpanel connector system is that the backpanel connector requires a hole in the backpanel wherein the first and second housings are accommodated resulting in limited routing freedom for optical and electrical signal tracks and electromagnetic interference.

It is an object of the invention to provide an optical connector system wherein holes are no longer required while optical and electrical interfaces can be appropriately established.

This object is achieved by providing an optical connector system characterized in that said backpanel comprises an integrated second optical interface part adapted to complete said optical interface and said substrate housing assembly is adapted to provide relative movement of said substrate with respect to said optical interface. By integrating the second optical interface part in the backpanel, less or none external connections such as cables or flexes are required, for transmission of signals between components of e.g. different substrates, while the movable substrate housing assembly ensures completion of the optical interface between the interface parts before the electrical connections are established. Thus, the movement of the housings to first establish the optical interface is provided at the substrate instead of at the backpanel. The substrate housing assembly comprises at least a component that is adapted to move with respect to the optical interface at least after said optical interface is formed. Consequently the backpanel housing can have an integrated optical interface part with increased routing possibilities and reduced influence of electromagnetic radiation.

In an embodiment of the invention the substrate housing assembly is slidably mounted on said substrate. This may e.g. be achieved by providing the substrate housing assembly or the substrate with one or more spring elements that respectively cooperate with the substrate or the substrate housing assembly. These spring elements may provide the relative movement of the substrate with respect to the optical interface to complete the optical interface before electrical connections are established.

In an embodiment of the invention the substrate housing assembly is attached to said substrate and comprises a further housing with said first interface part that is slidably mounted in a z-direction of said substrate housing assembly. Preferably the substrate housing assembly comprises a biasing arrangement for said further housing adapted to release said further housing substantially after completion of said optical interface. In such an embodiment after having completed the optical interface, the substrate housing assembly exerts no residual force on the backpanel. Consequently damage of components or signal tracks of the backpanel may be avoided. The further housing may be accommodated at least partly within the substrate housing assembly.

In an embodiment of the invention the further housing comprises at least one ferrule assembly for optical fibres at a mating side and alignment elements to align said first interface part and said second interface part. This alignment ensures an adequate optical connection resulting in a low loss optical interface. Preferably the backpanel comprises a backpanel housing assembly, wherein the backpanel housing assembly and the substrate housing assembly comprise locking elements adapted to lock said housings after completion of said optical interface. The locking elements prevent the optical interface to be interrupted accidentally.

The invention is particularly advantageous in a system wherein said backpanel comprises one or more first electrical contacts and said substrate comprises one or more second electrical contacts and said optical connector system is further arranged to establish electrical connections between said first and second electrical contacts after establishment of said optical interface.

The invention further relates to a substrate housing assembly for a substrate adapted for mounting to a backpanel housing assembly of a backpanel to establish an optical interface for optical connection between said substrate and said backpanel. The substrate housing assembly is adapted to comprise a further housing with a mating side forming a first interface part for said optical interface, said further housing being slidably mountable in a z-direction of said substrate housing assembly. Preferably the substrate housing assembly comprises biasing means adapted to release said further housing after completion of said optical interface.

The invention will be further illustrated with reference to the attached drawings, which show a preferred embodiment according to the invention. It will be understood that the invention is not in any way restricted to this specific and preferred embodiment.

### IN THE DRAWINGS

FIG. 1 schematically shows a part of an optical connector system with optical and electrical connections;

FIG. 2 shows an optical connector system according to a first embodiment of the invention;

FIG. 3 shows an exploded view of the backpanel housing assembly of the optical connector system of FIG. 2;

FIG. 4 shows an exploded view of the substrate housing assembly of the optical connector system of FIG. 2;

FIG. 5 shows an exploded view of the further housing of the substrate housing assembly of FIG. 4;

FIGS. 6A-6D show cross-sections of the optical connector system of FIG. 2 at several stages of connection;

FIG. 7 shows an optical connector system according to a second embodiment of the invention, and

FIGS. 8A-8D show cross-section of the optical connector system of FIG. 7 at several stages of connection.

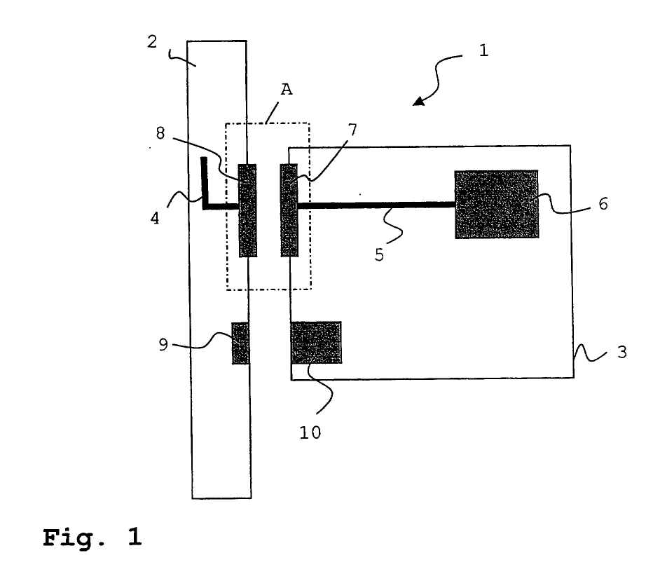

FIG. 1 displays a schematical illustration of an optical connector system 1 comprising a backpanel 2 and a substrate 3. Optical communication may be established via optical waveguides 4 and cables 5 with a component 6 on the substrate 3. The optical communication may involve a first interface part 7 and a second interface part 8 to establish an optical interface for the optical communication. The second interface part 8 is integrated in the backpanel 2. Further first electrical contacts 9 and second electrical contacts 10 are respectively provided at the backpanel 2 and the substrate 3 to allow transmission of electrical signals. As alignment is of crucial importance to provide a low loss optical interface, it is highly preferred for such optical connector systems 1 that the optical interfaces are completed before the electrical connections between the first and second electrical contacts 9, 10 are established, because the latter may otherwise disturb the alignment for the optical interface.

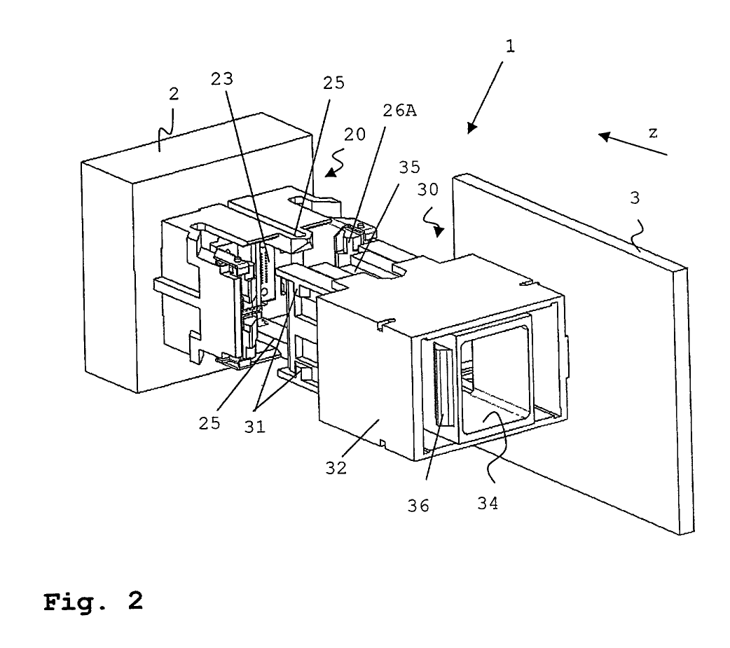

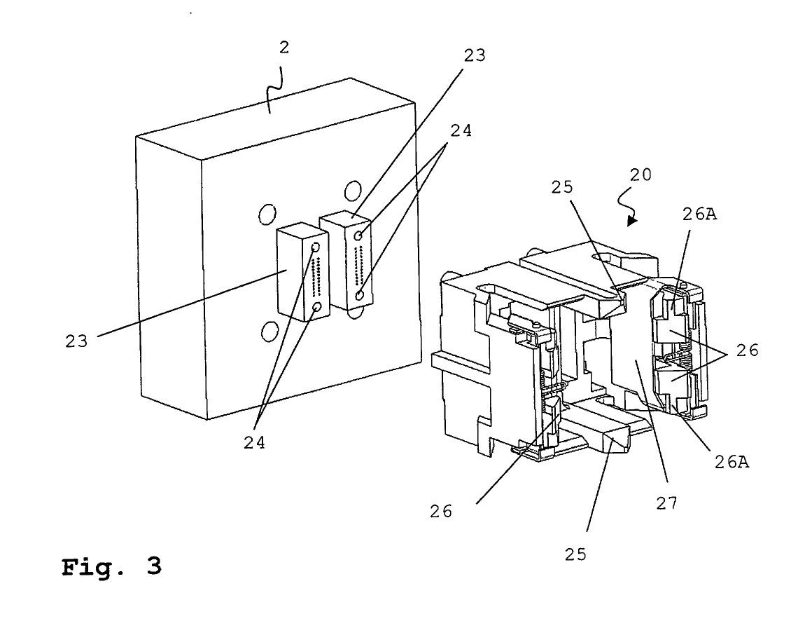

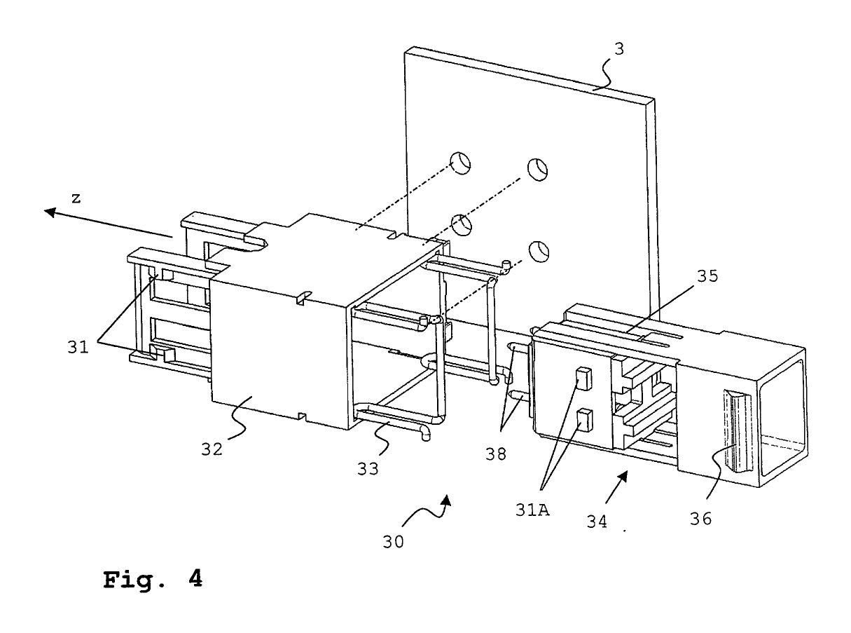

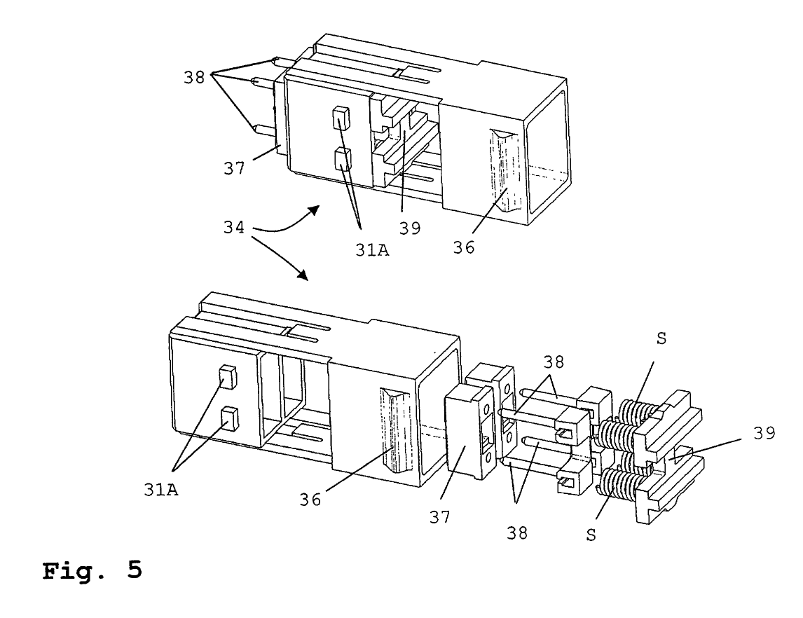

FIG. 2 shows a detailed view of the dashed area A of the optical connector system 1 of FIG. 1 comprising a backpanel housing assembly 20 mounted on the backpanel 2 and a substrate housing assembly 30 attached to the substrate 3. Detailed illustrations of the backpanel housing assembly 20 and the substrate housing assembly 30 are provided in FIG. 3 respectively FIGS. 4 and 5.

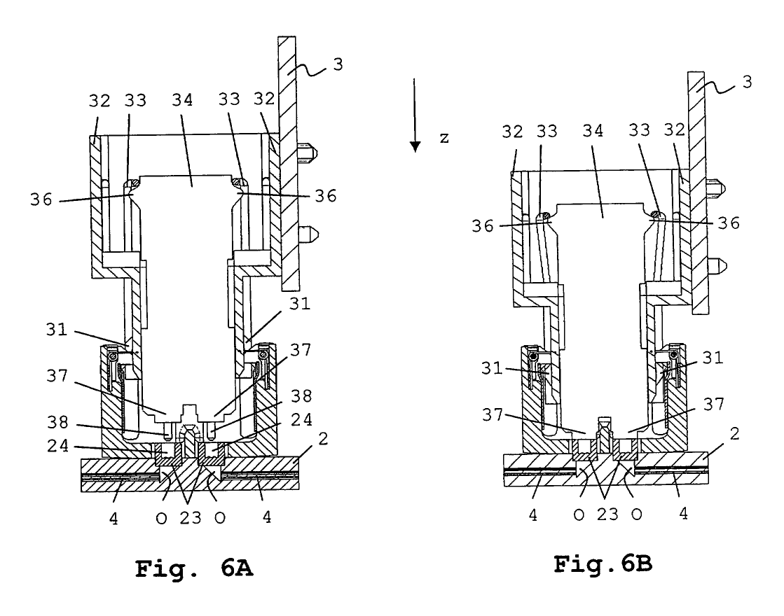

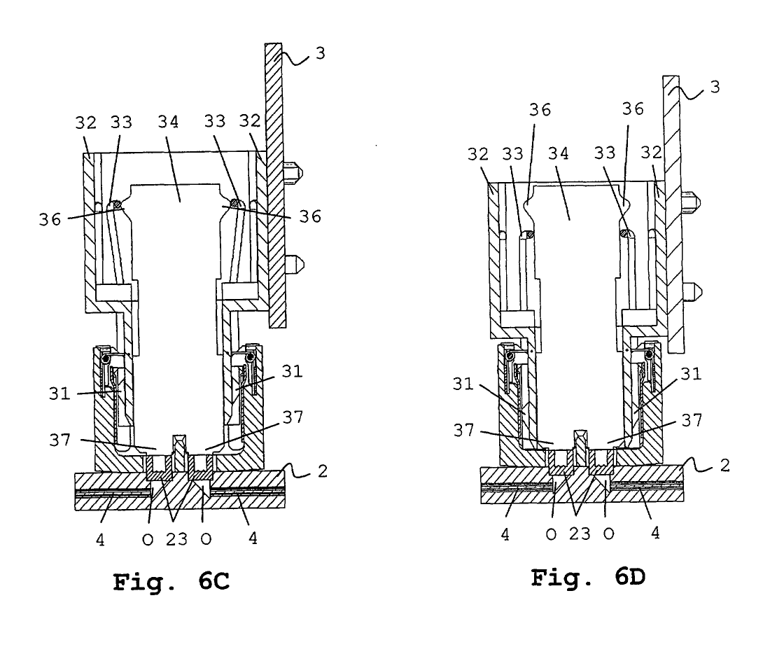

FIGS. 2 and 3 shows a backpanel 2 with the integrated second optical interface part 8 to allow optical communication with the waveguide 4 by employing ferrule parts 23. The ferrule parts 23 comprise a two-dimensional array of holes for optical fibres. The ferrule parts 23 further comprise alignment elements 24, e.g. holes, to align the second interface part 8 with the first interface part 7 at the side of the substrate as shown in more detail in FIG. 6.

The backpanel housing assembly 20 has a bottom portion that is at least partly open to at least receive a part of the ferrule parts 23. The backpanel housing assembly 20 may further be shaped or comprise mounting elements to mount the backpanel housing assembly 20 to the backpanel 2. The backpanel housing assembly 20 may further comprise guiding elements 25 facilitating connection of the backpanel housing assembly 20 and the substrate housing assembly 30. Further the backpanel housing assembly 20 comprises locking elements 26 that cooperate with corresponding elements 31A of the substrate housing assembly 30. Finally the backpanel housing assembly 20 is formed such that it may accommodate or attach shutters 27 for safety reasons,

FIGS. 2 and 4 further illustrate a substrate housing assembly 30 mounted on a substrate 3 according to an embodiment of the invention. The substrate housing assembly 30 comprises an outer substrate housing 32, a biasing arrangement 33 and a further housing or insert 34.

The insert 34 comprises guiding structures 35 adapted to cooperate with the guiding elements 25 of the backpanel housing assembly 20. The outer substrate housing 32 comprises lifter elements 31 adapted to cooperate with the lifter elements 26A of the backpanel housing assembly 20.

The biasing arrangement 33 may comprise a suitably shaped spring that is attached to the substrate housing 32. The spring 33 cooperates with a protrusion 36 of the insert 34 as will be discussed in detail with reference to FIG. 6. Alternatively the spring 33 may be attached to the insert 34 and cooperate with one or more suitable parts of the outer housing 32.

FIG. 5 shows a more detailed illustration of the insert 34 in an assembled state and in exploded view of FIGS. 2 and 4. The insert 34 accommodates ferrule parts 37 wherein optical fibres of a cable 5 (not shown in FIG. 5) terminate for forming the first interface part 7 of the optical interface to be established on connection with the ferrule parts 23 at the side of the backpanel housing assembly 20. The ferrule parts 37 comprise holes to have inserted pins 38 as alignment elements for aligning the ferrule parts 23 and 37 by cooperation with the alignment holes 24. The arrangement is maintained in position by a closing cap 39 employing springs S such that the ferrule parts 37 protrude from the front side of the insert 34.

In FIGS. 6A-6D the operation on connection of the optical connector system 1 according to a first embodiment of the invention is illustrated. Details of the insert 34 as displayed in FIG. 5 have been omitted for reasons of clarity. The z-direction of the system is indicated in the FIGS. 6A-6D and extends parallel to the normal of the backplane 2. The backplane 2 comprises the waveguides 4 and optical assemblies O to deflect optical signals. Details of such optical assemblies O are described in the non-prepublished Dutch patent application NL1021205 of the applicant.

First, as shown in FIG. 6A, the substrate housing assembly 30 mounted on the substrate 3 approaches the backpanel housing assembly 20 mounted on the backpanel 2. The backpanel 2 comprises the integrated second interface part 8 formed by the ferrule parts 23 having alignment elements 24. The insert 34 protrudes from the substrate housing 32 and may be initially prevented to slip into the housing 32 by means of the spring element 33. The mating side of the insert 34 comprises the ferrule parts 37 and the pins 38 and is inserted into the backpanel housing assembly 20.

Subsequently in FIG. 6B the optical interface is formed as the first ferrule parts 23 and the second ferrule parts 37 mate assisted by the cooperating alignment elements 24 and 38. The leading parts of the lifter elements 31 of the substrate housing 32 deflect the corresponding lifter elements 26A of the backpanel housing assembly 20. The spring element 33 cooperates with the protrusions 36 of the insert 34 to create a spring load or bias allowing the application of force to form the optical interface. Now the locking element 26 of the back panel housing 20 locks behind the corresponding locking element 31A of the insert 34. At this stage the electrical contacts 9, 10 have not yet been made such that the alignment of the optical interface is not disturbed by the formation of the electrical contact.

In the next stage illustrated in FIG. 6C the substrate 3 further approaches the backpanel 2 to mate the first and second electrical contacts 9 and 10 without affecting the locked optical interface of FIG. 6B. This is achieved in this first embodiment by having an insert 34 that is slidably mounted in the z-direction or longitudinal direction with respect to the substrate housing 32. The spring element 33 no longer cooperates with the protrusions 36 such that the insert 34 is released as illustrated in FIG. 6C. Accordingly virtually no spring load remains for the backpanel 2.

Finally in FIG. 6D the backpanel housing assembly and the substrate housing assembly are in the final position and both the optical interfaces and electrical contacts (not shown) have been formed.

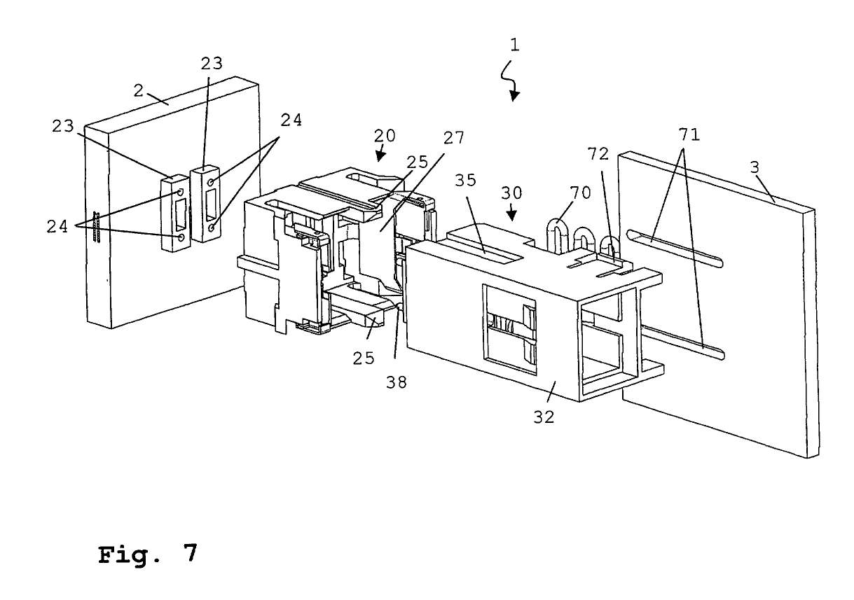

FIG. 7 shows a second embodiment of the invention, wherein insert 34 of the substrate housing assembly 30 is no longer slidable. Instead, the substrate housing assembly 30 itself is slidably mounted with respect to the substrate 3 by spring element 70 attached to the substrate 3. The substrate 3 is provided with recesses 71 adapted to cooperate with extension 72 of the substrate housing assembly 30. Consequently the application of a force to the substrate housing assembly 30 allows the housing 30 to move relatively to the substrate 3 to an extent defined by the lengths of the recesses 71. The spring element 70 is preferably more stiff than the spring S for the ferrule part 37 to allow the application of force to establish the optical interface. If the optical interface is completed the spring element 70 enables the substrate 3 to move with respect to the optical interface to allow establishment of the electrical contacts 9, 10 (not shown). It is noted that the first optical interface part 7 of the substrate housing 30 not necessarily should be provided as an insert 34.

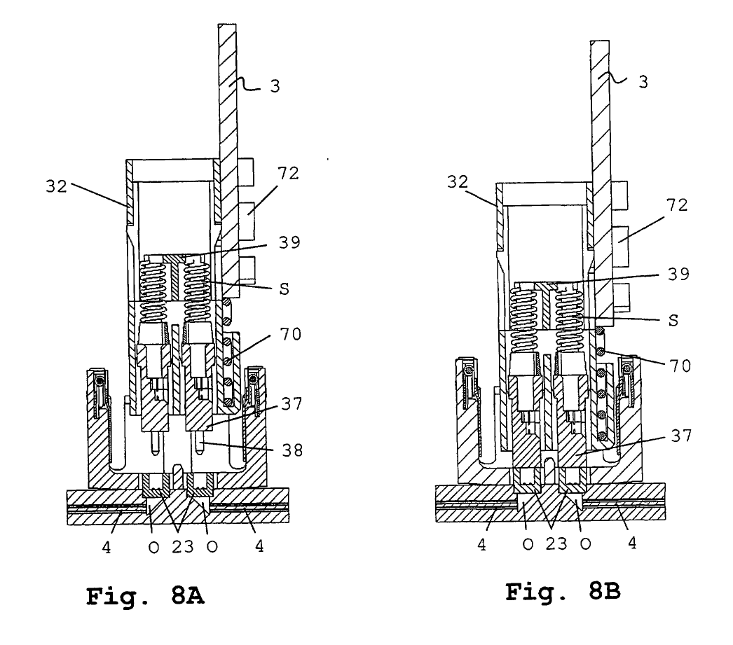

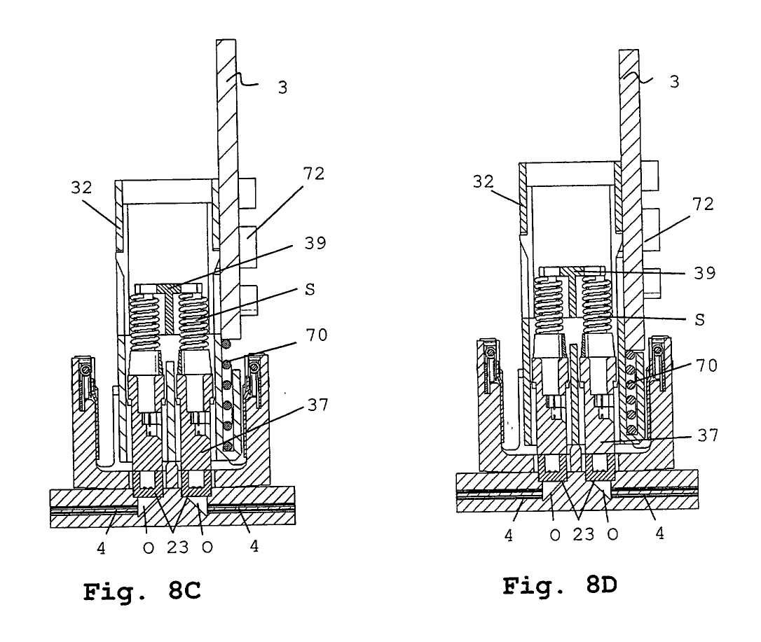

In FIGS. 8A-8D the operation on connection of the optical connector system 1 according to the second embodiment of the invention is illustrated. Identical reference numerals have been used to indicate similar components of the optical connector system 1.

First, as shown in FIG. 8A, the substrate housing assembly 30 mounted on the substrate 3 approaches the backpanel housing assembly 20 mounted on the backpanel 2. The backpanel 2 comprises the integrated second interface part 8 formed by the ferrule parts 23 having alignment elements 24. The mating side of the insert 34 comprises the ferrule parts 37 and the pins 38 and is inserted into the backpanel housing assembly 20. The substrate housing assembly 30 is slidably mounted with respect to the substrate 3 by spring elements 70.

Subsequently in FIG. 8B the optical interface is formed and locked as the first ferrule parts 23 and the second ferrule parts 37 mate assisted by the cooperating alignment elements 24 and 38. At this stage the electrical contacts 9, 10 have not yet been made such that the alignment of the optical interface is not disturbed by the formation of the electrical contact.

In the next stage illustrated in FIG. 8C the substrate 3 further approaches the backpanel 2 to mate the first and second electrical contacts 9 and 10 without affecting the locked optical interface of FIG. 8B. This is achieved in that the substrate housing assembly 30 slides backwards facilitated by the spring element 70 as to maintain the optical interface. A spring force thus develops on the backpanel 2. The spring element 70 preferably is chosen such that this spring force on the backpanel 2 is minimal.

Finally in FIG. 8D the backpanel housing assembly and the substrate housing assembly are in the final position and both the optical interfaces and electrical contacts (not shown) have been formed.

1. Optical connector system comprising a backpanel and at least one substrate having at least one substrate housing assembly and a first interface part for establishing an optical interface characterized in that said backpanel comprises an integrated second interface part adapted to complete said optical interface and said substrate housing assembly is adapted to provide relative movement of said substrate with respect to said optical interface.

2. Optical connector system according to claim 1, wherein said substrate housing assembly is slidably mounted on said substrate.

3. Optical connector system according to claim 1, wherein said substrate housing assembly is attached to said substrate and comprises a further housing with said first interface part that is slidably mounted in a z-direction of said substrate housing assembly.

4. Optical connector system according to claim 3, wherein said substrate housing assembly comprises a biasing arrangement for said further housing adapted to release said further housing substantially after completion of said optical interface.

5. Optical connector system according to claim 3, wherein said further housing comprises at least one ferrule assembly for optical fibres at said mating side and alignment elements to align said first interface part and said second interface part.

6. Optical connector system according to claims 3, wherein said further housing is at least partly accommodated within said substrate housing assembly.

7. Optical connector system according to claim 1, wherein said backpanel comprises a backpanel housing assembly and said substrate housing assembly comprise locking elements adapted to lock said housings after completion of said optical interface.

8. Optical connector system according to claim 1, wherein said backpanel comprises one or more first electrical contacts and said substrate comprises one or more second electrical contacts and said optical connector system is further arranged to establish electrical connections between said first and second electrical contacts substantially after completion of said optical interface.

9. Substrate housing assembly for a substrate adapted for mounting to a backpanel housing assembly of a backpanel to establish an optical interface for optical communication between said substrate and said backpanel characterized in that said substrate housing assembly being adapted to comprise a further housing with a mating side forming a first interface part for said optical interface, said further housing being slidably mountable in a z-direction of said substrate housing assembly.

10. Substrate housing assembly according to claim 9, wherein said substrate housing assembly comprises biasing means adapted to release said further housing after completion of said optical interface.
